(19) United States
(12) Patent Application Publication
(10) Pub. No.: US 2026/0342669 A1
(43) Pub. Date: Oct. 29, 2026

(54) SYSTEM FOR PREDICTING NETWORK TRAFFIC

(71) Applicant: Telecom Italia S.p.A., Milano (IT)

(72) Inventors: Gianluca Francini, Torino (IT); Giorgio Ghinamo, Torino (IT); Shuyang Li, Torino (IT); Enrico Magli, Torino (IT)

(21) Appl. No.: 19/110,781

(22) PCT Filed: Sep. 6, 2023
(86) PCT No.: PCT/EP2023/074448

§ 371 Date: Mar. 11, 2025

(30) Foreign Application Priority Data
Sep. 12, 2022 (IT) 102022000018537

(51) Int. Cl. H04L 41/147

(52) U.S. Cl. CPC H04L 41/147

(57) ABSTRACT

A system coupled with a wireless communication network is provided. The system comprises:—a predictor module configured to generate a network traffic prediction indicative of a number of user terminals in a target area under radio coverage by the wireless communication network during a first period following a second time period. The predictor module comprises a first submodule configured to generate a first operative prediction of a number of user terminals in the target area during the first time period based on historical user terminal density indicators indicative of a density of user terminals in the target area in a past time period occurred before the second time period;—a second submodule configured to generate a second operative prediction of the number of user terminals in the target area during the first time period based on a combination of the historical user terminal density indicators and real time user terminal position indicators indicative of a movement of user terminals at the target area during the second time period;—a third submodule configured to provide, at the second period, the network traffic prediction based on a selected one between the first operative prediction and the second operative prediction. The system further comprises a network optimization unit configured to regulate function parameters of the wireless communication network based on said network traffic prediction.

### BACKGROUND OF THE PRESENT INVENTION

### Field of the Present Invention

The present invention generally relates to the traffic analysis field. More particularly, the present invention relates to a method and system aimed at predicting network traffic of a wireless communication network caused by variations in the geographical density of people (e.g., users of user terminals connected to the wireless communication network) moving in a geographic region of interest.

### Overview of the Related Art

Predicting network traffic of a wireless communication network provides benefits for improving the operation of the wireless communication network. Accurate network traffic forecasting allows a communication network to efficiently react to changes in the network traffic by accordingly tuning corresponding wireless communication network function parameters, such as for example by increasing the amount of network resources at specific portions of the wireless communication network where high network traffic is expected, or by changing radio parameter configurations (e.g., by varying the tilt of the antennas and/or the transmission power) based on the forecasted network traffic.

In order to carry out traffic analysis for predicting number of user terminals (e.g., smartphones) of a wireless communication network in a geographic area (hereinafter briefly referred to as “target area”), it is known to exploit data exchanged between the user terminals (e.g., smartphones) and base stations of the wireless communication network (e.g., a Long-Term Evolution (LTE) network or a 5G network) pertaining to said target area.

The tracking of the cell identifier (cell ID) which identifies the cell of the wireless communication network wherein network events providing for the interaction of user terminals with the wireless communication network (e.g., voice calls, data transmission, periodic updating) are carried out can be advantageously exploited for traffic analysis purposes. For this purpose, it is useful to take advantage of the network database containing information about the geographic positions of the various cells of the wireless communication network (e.g., the position of the corresponding base stations and the associated cell coverage).

Making reference to a 5G wireless communication network, it is possible to use the known user location detection procedure referred to as Minimization of Drive Test (MDT) in order to track the position and movement of user terminals. The MDT procedure provides that the wireless communication network periodically reads the Global Navigation Satellite System (GNSS) (e.g., Global Positioning System (GPS), GLONASS, Galileo) position of the user terminals which are connected to the wireless communication network itself, obtaining thus information about the locations and movements of the user terminals. When a user terminal is located in a place wherein its GNSS position is not available (e.g., when the user terminal is inside a building), or the GNSS functionality is disabled, the MDT procedure is able to determine the location of a user terminal by measuring its radio signal.

Solutions are known in which network traffic predictions are made by processing, through a machine learning engine, indicators of user terminal density, hereinafter referred to as “historical user terminal density indicators”, that are generated based on the observation of the wireless communication network during past observation times. Examples of historical user terminal density may comprise a number of user terminals connected to the wireless network, a number of active user terminals, a number of user terminals having carried out an interaction with the wireless communication network, and so on.

U.S. Pat. No. 10,862,788B2 discloses a method for evaluating and predicting telecommunications network traffic that includes receiving site data for multiple geographic areas via a processor. The processor also receives weather data, event data, and population demographic data for the geographic areas. The processor also generates predicted occupancy data for each of the geographic areas and for multiple time intervals. The processor also determines a predicted telecommunications network metric for each of the geographic areas and for each of the time intervals, based on the predicted occupancy data.

U.S. Pat. No. 10,862,781B2 discloses methods, systems, and apparatus, including computer programs encoded on a computer storage medium, for improving the connectivity and response speed throughout a network. In one aspect, a method includes receiving network traffic data from an aggregation point on a network, the network traffic data having been sent to or received from one of a plurality of end-point devices on the network, calculating performance metrics for each of the end-point devices based the received network traffic data, for each of the end-point devices, comparing the performance metrics to respective threshold values to determine performance issues for the network, wherein the threshold values are determined based on historical network data, correlating the determined performance issues for the network to an aspect of the end-point devices, and implementing an action to correct the determined performance issues for the network based on the

### Summary of the Present Invention

Applicant has observed that the solutions known in the art are not efficient, being affected by drawbacks.

Particularly, the machine learning solutions providing for generating predictions exploiting historical user terminal density indicators are capable of giving satisfactory results only in those conditions for which the density of user terminals is within expected ranges. These solutions are far less efficient in those cases in which a peak in the user terminal density occurs because of unusual/unexpected causes, such as when a large number of user terminals is moving toward the target area because of a public happening (e.g., a concert, a sport match) occurring in the target area. This is particularly exacerbated by the fact that the conditions for the occurrences of these peaks are not suited to be used for training the machine learning engine. Indeed, because the occurrence of these kind of peaks is scarce, they are not sufficiently represented in the usual training datasets.

In view of the above, Applicant has devised an improved system for predicting network traffic caused by variations in the geographical density of people moving in a geographic region of interest that is not affected by the abovementioned drawbacks.

One or more aspects of the present invention are set out in the independent claims, with advantageous features of the same invention that are indicated in the dependent claims, whose wording is enclosed herein verbatim by reference (with any advantageous feature being provided with reference to a specific aspect of the present that applies mutatis mutandis to any other aspect thereof). An aspect of the present invention relates to a system coupled with a wireless communication network.

The system comprises a predictor module configured to generate a network traffic prediction indicative of a number of user terminals in a target area under radio coverage by said wireless communication network during a first period following a second time period.

The predictor module comprises a first submodule configured to generate a first operative prediction of a number of user terminals in the target area during said first time period based on historical user terminal density indicators indicative of a density of user terminals in said target area in a past time period occurred before said second time period.

The predictor module further comprises a second submodule configured to generate a second operative prediction of said number of user terminals in the target area during said first time period based on a combination of said historical user terminal density indicators and real time user terminal position indicators indicative of a movement of user terminals at said target area during said second time period.

The predictor module further comprises a third submodule configured to provide, at said second period, said network traffic prediction based on a selected one between said first operative prediction and said second operative prediction.

The system further comprises a network optimization unit configured to regulate function parameters of the wireless communication network based on said network traffic prediction.

According to an embodiment of the present invention, said historical user terminal density indicators comprise at least one among:
a number of user terminals connected to the wireless communication network;
a number of user terminals whose last interaction with the wireless communication network occurred in a cell of the wireless communication network corresponding to the target area;
a number of active user terminals;
traffic volumes caused by user terminals connected to the wireless communication network, collected in said past time period occurred before said second time period.

According to an embodiment of the present invention, said real time user terminal position indicators comprise at least one among:
GNSS records each containing at least a GNSS position of a user terminal located at the target area during said second time period;
user terminal position indicators generated by interactions of user terminals at the target area with the wireless communication network during said second time period.

According to an embodiment of the present invention, said first submodule is configured to generate said first operative prediction by processing said historical user terminal density indicators through a machine learning algorithm.

According to an embodiment of the present invention, said second submodule is configured to generate said second operative prediction by comparing said historical user terminal density indicators with said real time user terminal position indicators.

According to an embodiment of the present invention, the third submodule is configured to provide, at said second period, said traffic prediction based on the second operative prediction if both the two following conditions are verified:
the number of user terminals corresponding to the first operative prediction is lower than a number of user terminals at the target area assessed based on the real time user terminal position indicators, and
the difference between the number of user terminals at the target area assessed based on the real time user terminal position indicator and the number of user terminals corresponding to the first operative prediction is higher than a threshold.

According to an embodiment of the present invention, the third submodule is configured to provide, at said second period, said traffic prediction based on the second operative prediction if the first operative prediction is indicative of a peak in the number of user terminals in said target area.

According to an embodiment of the present invention, the third submodule is configured to receive calendar data providing indications of scheduled increases in the number of user terminals in the target area, the third submodule being further configured to provide, at said second period, said traffic prediction based on the second operative prediction if the calendar data provide an indication of an increase in the number of user terminals in the target area scheduled for said first time period.

According to an embodiment of the present invention, the first submodule is configured to:
subdivide a range of possible values for the first operative prediction into a set of sub-intervals, and
calculate a prediction probability distribution providing for each sub-interval an indication of a reliability of the first operative prediction corresponding to the values of the sub-interval, wherein the third computation submodule is configured to provide, at said second period, said traffic prediction based on the second operative prediction if the prediction probability distribution PD is lower than a reliability threshold for all the sub-intervals.

According to an embodiment of the present invention, the third submodule is configured to provide, at said second period, said traffic prediction based on the second operative prediction if said second operative prediction is indicative of a peak in the number of user terminals in said target area.

According to an embodiment of the present invention, the system further comprises a self-organizing-network module configured to regulate function parameters of the wireless communication network based on said network traffic prediction.

According to an embodiment of the present invention, the system further comprises a drone cell module configured to drive a drone equipped with a cell site of the wireless communication network to the target area based on said network traffic prediction.

### BRIEF DESCRIPTION OF THE DRAWINGS

FIG. 1 is a schematic representation of a system comprising a predictor module for analyzing traffic in a target area according to an embodiment of the present invention;

FIGS. 2A-2D are diagrams of experimental results showing behaviors over time of density

FIGS. 3A-3E depict flow charts showing main operations performed by the system of FIG. 1 according to embodiments of the present invention.

### DETAILED DESCRIPTION OF EXEMPLARY AND NON-LIMITATIVE EMBODIMENTS OF THE PRESENT INVENTION

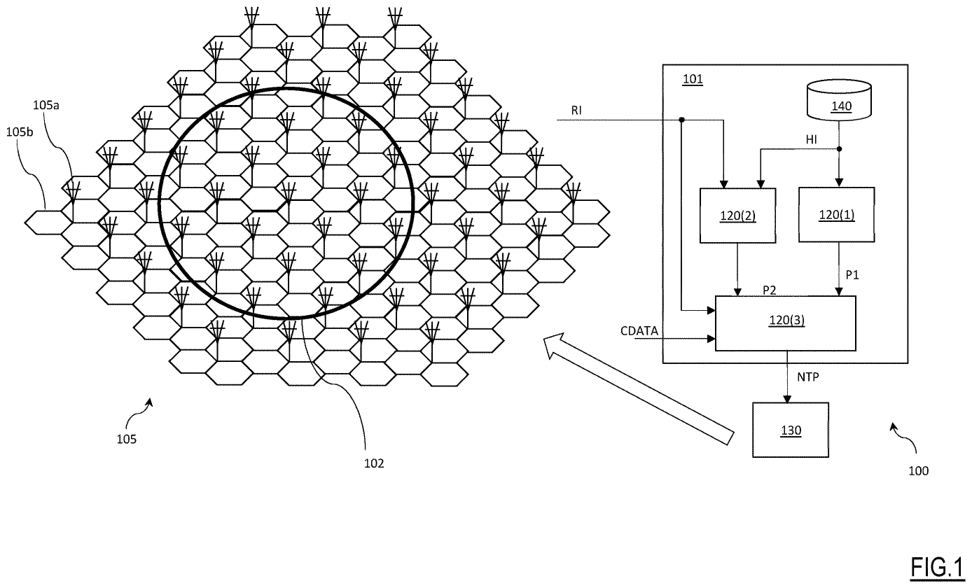

With reference to the drawings, FIG. 1 schematically illustrates a system 100 comprising a predictor module 101 for analyzing traffic directed to generate a network traffic prediction NTP indicative of a number of user terminals UT (e.g., smartphones) in a target area 102 according to an embodiment of the present invention. It should be noted that the terms ‘unit’, “system’, ‘module’ are herein intended to comprise, but not limited to, hardware, firmware, a combination of hardware and software, software.

The target area 102 is under radio coverage by a wireless communication network 105, such as a (2G, 3G, 4G, 5G or higher generation) mobile telephony network, comprising a plurality of (three or more) base stations 105a geographically distributed through a corresponding region including the target area 102. Each base station 105a is adapted to manage communication of user terminals UT in one or more served areas or cells 105b. In the example at issue, three cells 105b are served by each base station 105a, but similar considerations apply in case a different number of cells 105b is served by each base station 105a.

Each base station 105a of the wireless communication network 105 is adapted to interact with any user terminal UT located within one of the cells 105b served by such base station 105a. Such interactions between user terminals UT and wireless communication network 105 will be generally denoted as “network events”, and may comprise (non exhaustively) interactions at power on/off, at incoming/outgoing voice calls, at sending/receiving SMS, at Internet access, at generic data transfers, etc.

According to an embodiment of the present invention, the predictor module 101 comprises:
a first computation submodule 120(1) configured to generate a first operative prediction P1 of a number of user terminals UT that will be present in the target area 102 during a corresponding future time period FTP not yet occurred;
a second computation submodule 120(2) configured to generate a second operative prediction P2 of a number of user terminals UT that will be present in the target area 102 during the future time period FTP.

As will be described in greater detail in the following of the present description, the two operative predictions P1 and P2 generated by the computation submodules 120(1), 120(2) according to the embodiments of the present invention are generally different, being obtained based on different principles and using different datasets and different type of data, and are suitable to be considered in

According to an embodiment of the present invention, the predictor module 101 further comprises a third computation submodule 120(3) configured to provide the network traffic prediction NTP indicative of a number of user terminals UT in a target area 102 based on a selected one between the operative predictions P1 and P2.

According to an embodiment of the present invention, the system 100 further comprises a network optimization unit 130 configured to regulate function parameters of the wireless communication network 105 based on the network traffic prediction NTP provided by the third computation submodule 120(3) of the predictor module 101, so as to allow the wireless communication network 105 to efficiently react to changes in the network traffic in such a way to provide a sufficient quality of service without wasting a too excessive amount of network resources. For example, according to an embodiment of the present invention, the network optimization unit 130 may comprise a self-organizing-network module configured to automatically regulate function parameters of the wireless communication network (e.g., the amount of network resources allocated for transmissions at the cells 105b of the wireless communication network 105 included in the target area 102, and/or antenna configurations of the base stations 105a serving those cells 105b) based on the network traffic prediction NTP. According to another exemplary embodiment of the invention, the network optimization unit 130 may comprise a drone cell module configured to drive a drone equipped with a cell site of the wireless communication network 105 to the target area 102 based on said network traffic prediction.

According to an embodiment of the present invention, the first computation submodule 120(1) is configured to generate the first operative prediction P1 based on historical user terminal density indicators HI indicative of a density of user terminals UT in the target area 102 in a past time period PATP, and therefore providing an indication of the historical network traffic behavior in the target area 102.

By past time period PATP it is herein intended a period of time of a certain length (for example, corresponding to a number of hours, a number of days, a number of weeks, a number of months, a number of years) occurred substantially before the current time during which the first computation submodule 120(1) is generating the first operative prediction P1. The past rime period PATP temporally precedes the future time period FTP.

According to an embodiment of the present invention, the historical user terminal density indicators HI comprise at least one among the following indicators collected in said past time period PATP:
a number of user terminals UT connected to the wireless communication network 105;
a number of user terminals UT whose last interaction (network event) with the wireless communication network 105 occurred in a cell 105b included in the target area 102;
a number of active user terminals UT;
traffic volumes caused by user terminals UT connected to the wireless communication network 105.

According to an embodiment of the present invention, the historical user terminal density indicators HI are stored in a corresponding repository module 140, which is included in or coupled to the predictor module 101.

According to an embodiment of the present invention, the first computation submodule 120(1) is configured to generate the first operative prediction P1 by processing the historical user terminal density indicators HI through a machine learning algorithm. For this reason, according to an embodiment of the present invention, the first computation submodule 120(1) is equipped with a machine learning engine trained to generate the first operative prediction P1 by taking into account the history of the network traffic within the target area 102 obtained through the historical user terminal density indicators HI.

According to an embodiment of the present invention, the machine learning engine of the first computation submodule 120(1) is configured to implement a deep learning algorithm, such as for example a Mixture-of-Experts based on deep learning models. The concepts of the present invention can be also applied in case the machine learning engine of the first computation submodule 120(1) is configured to operate according to different neural network approaches, such as for example one among the known Convolutional Neural Network approach, Long-Short Memory Network approach, Multi-Horizon Quantile Recurrent Forecaster approach, Deep AutoRegressive Recurrent Neural Network approach, Graph Convolutional Network approach. Moreover, the concepts of the present invention can be also extended to those cases in which forecasts are made according to the Autoregressive Integrated Moving Average approach and to the AutoRegressive Conditional Heteroskedasticity approach. According to an embodiment of the present invention, in order to improve the accuracy of the first operative prediction P1 generated by the first computation submodule 120(1), the content of the repository module 140 is, for example, periodically, updated with new collected historical user terminal density indicators HI.

According to an embodiment of the present invention, the length of the past time period PATP depends on the algorithm/approach implemented by the first computation submodule 120(1). For example, for a Mixture-of-Experts based on deep learning models, the past time period PATP may be equal to about 2 weeks, and for the Graph Convolutional Network approach the past time period PATP may be equal to about 16 weeks.

According to an embodiment of the present invention, the first computation submodule 120(1) may be subjected to training every week, in order to update the prediction models.

The longer the considered past time period PATP, the larger the amount of available data, and therefore the higher the prediction accuracy (with a same statistical behavior of the communication network cells). However, if the statistical behavior of one or more cells of the communication network varies, considering a too long past time period PATP may be counter-productive, since in this case the predictor employs more time to adapt to the new behavior.

The first operative prediction P1 generated by the first computation submodule 120(1) through machine learning algorithm exploiting historical observations of the network traffic (i.e., through the historical user terminal density indicators HI) is particularly suited to predict the number of user terminals UT in the target area 102 in case the network traffic in the considered cells 105b has a regular historical behavior, i.e., in those conditions for which the behavior over time of the density of user terminals UT has been observed to follow a (quasi-)regular pattern occurring within expected ranges. In these cases, the first computation submodule 120(1) is capable of correctly forecasting the occurrences of peaks in the number of user terminals UT in the target area 102, i.e., it is capable of generating a first operative prediction P1 providing for a sufficiently correct determination of the time of occurrence of a peak as well as a sufficiently correct quantification of the number of user terminals UT corresponding to said peaks.

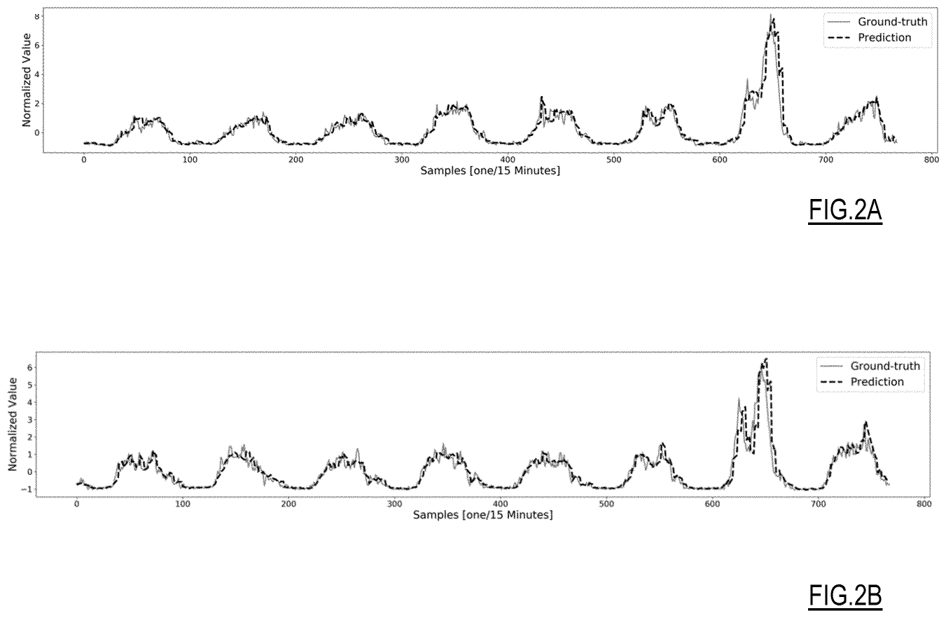

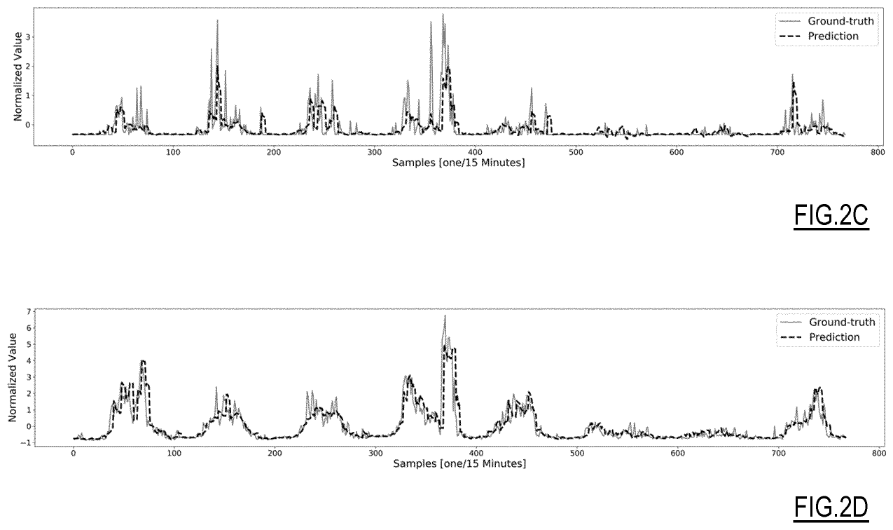

FIGS. 2A and 2B are diagrams of experimental results pertaining to two cells 105b within the target area 102 for which the behavior over time of the density of user terminals UT has been observed to follow a (quasi-)regular pattern occurring within expected ranges. The solid line corresponds to the actual evolution over time of the number of user terminals UT, while the dashed line corresponds to the number of user terminals UT corresponding to first operative predictions P1 generated by the first computation submodule 120(1) processing historical user terminal density indicators HI with a Mixture-of-Experts based on deep learning models. By observing the pictures it can be seen that the first operative predictions P1 generated by the first computation submodule 120(1) are decidedly accurate.

The first operative prediction P1 generated by the first computation submodule 120(1) through machine learning algorithm exploiting historical observations of the network traffic (i.e., through the historical user terminal density indicators HI) is instead not suited to predict the number of user terminals UT in the target area 102 in case the network traffic in the considered cells 105b is subjected to peaks occurring because of unusual/unexpected causes, such as when a large number of user terminals UT is moving toward the target area 102 because of a public happening (e.g., a concert, a sport match) is occurring in the target area 102. In these cases-two examples of which are illustrated in the diagrams of FIGS. 2C and 2D—the first computation submodule 120(1) is not capable of correctly forecasting the occurrences of peaks in the number of user terminals UT in the target area 102, i.e., the generated first operative prediction P1 provides for a wrong determination of the time of occurrence of a peak and/or an incorrect quantification of the number of user terminals UT corresponding to said peak.

Returning to FIG. 1, according to an embodiment of the present invention, the second computation submodule 120(2) is configured to generate the second operative prediction P2 based on a combination between:
the historical user terminal density indicators HI indicative of the density of user terminals UT in the target area 102 in the past (i.e., in the past time period PATP), providing an indication of the historical network traffic behavior in the target area 102, and
real time user terminal position indicators RI collected from the user terminals UT and indicative of movements of user terminals UT at said target area 102 during a present time period PRTP, i.e., from which it is possible to obtain a real time or quasi-real time indication of the movement of user terminals UT toward/away from/within the target area 102.

By present time period PRTP it is herein intended a period of time of a certain length (for example, corresponding to a number of minutes or hours) comprising or preceding the current time during which the second computation submodule 120(2) is generating the second operative prediction P2. The past time period PATP corresponding to the historical user terminal density indicators HI temporally precedes the present time period PRTP. The present time period PRTP temporally precedes the future time period FTP.

According to an embodiment of the present invention, the real time user terminal position indicators RI are collected from the user terminals UT and comprise at least one between:
GNSS (e.g., GPS, GLONASS, Galileo) records each containing at least a GNSS position of a user terminal UT located at (i.e., within and/or close to and moving toward/away from) the target area 102 during said present time period PRTP;
user terminal position indicators generated by interactions (network events) of user terminals UT located at (i.e., within and/or close to and moving toward/away from) the target area 102 with the wireless communication network 105 during said present time period PRTP.

According to an embodiment of the present invention, the real time user terminal position indicators RI are collected by the wireless communication network 105 and sent to the second computation submodule 120(2), for example by means of known MDT procedures.

The second operative prediction P2 generated by the second computation submodule 120(2) is particularly suited to predict the number of user terminals UT in the target area 102 in case the network traffic in the considered cells 105b is subjected to peaks occurring because of unusual and unexpected movements of user terminals UT within or toward the target area 102, since said prediction is carried out by the second computation submodule 120(2) by taking into account also real time user terminal position indicators RI from which it is possible to obtain a real time or quasi-real time indication of the movement of user terminals UT at (i.e., within and/or close to and moving toward/away from) the target area 102.

The second computation submodule 120(2) is particularly configured to predict in advance consistent flows-detectable from the movement of the user terminals UT-towards/away from the target area 102 generated by unusual and unexpected situations.

According to an embodiment of the present invention, the second computation submodule 120(2) is configured to generate the second operative prediction P2 by comparing the historical user terminal density indicators HI with the real time user terminal position indicators RI. In this way, the prediction is generated by having the knowledge of the present (or the just upcoming) network traffic situation, and therefore by having the knowledge of how much the network traffic situation deviates from the regular traffic corresponding to the historical user terminal density indicators HI. It is pointed out that when there is no consistent flow of user terminals UT toward/away from the target area 102, no useful information can be extracted from the real time user terminal position indicators RI capable of increasing the prediction accuracy. On the contrary, in these cases the real time user terminal position indicators RI may reduce the prediction accuracy, behaving as noisy data. According to an exemplary but not limitative embodiment of the present invention, the second computation submodule 120(2) may be based on the method and system disclosed in the published International application WO 2020/002094 by the same Applicant of the present application, i.e., it is configured to predict the number of user terminals UT in the target area 102 based on a difference between:
a first term indicative of the number of user terminals UT which are moving from an external area to an intermediate area surrounding the target area 102 (with the external area surrounding the intermediate area) during the present time period PRTP, and
a second term indicative of the number of user terminals UT which, during a portion of the past time period PATP matching the present time period PRTP, moved from the external area to the intermediate area.

According to an embodiment of the present invention, the first term is calculated by the second computation submodule 120(2) through a processing of the real time user terminal position indicators RI.

According to an embodiment of the present invention, the second term is calculated by the second computation submodule 120(2) through a processing of the historical user terminal density indicators HI.

As already mentioned above, according to an embodiment of the present invention, the third computation submodule 120(3) is configured to provide the network traffic prediction NTP indicative of a number of user terminals UT in a target area 102 based on a selected one between the operative predictions P1 and P2. As will be described in greater detail in the following, the selection of the operative prediction P1 or of the operative prediction P2 according to an embodiment of the present invention may be performed by the third computation submodule 120(3) according to one or more among:
a comparison between the number of user terminals UT corresponding to the first operative prediction P1 and a number of user terminals UT at the target area 102 assessed based on the real time user terminal position indicators RI;
the first operative prediction P1 itself;
calendar data CDATA received by the third computation submodule 120(3) and providing indications of scheduled increases in the number of user terminals UT in the target area 102;
a prediction probability distribution PD providing an indication of how reliable is the first operative prediction P1 across prediction value subintervals;
the second operative prediction P2 itself.

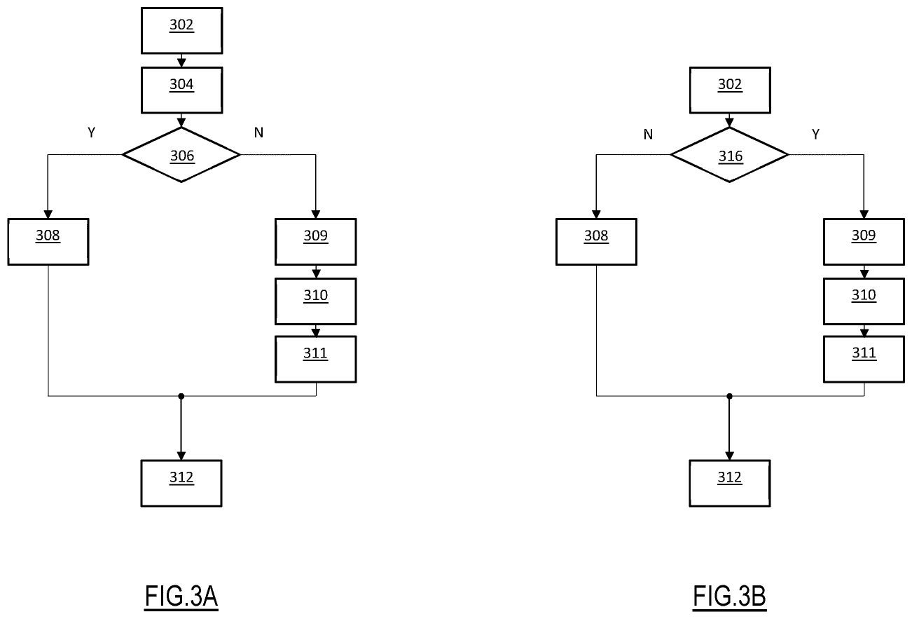

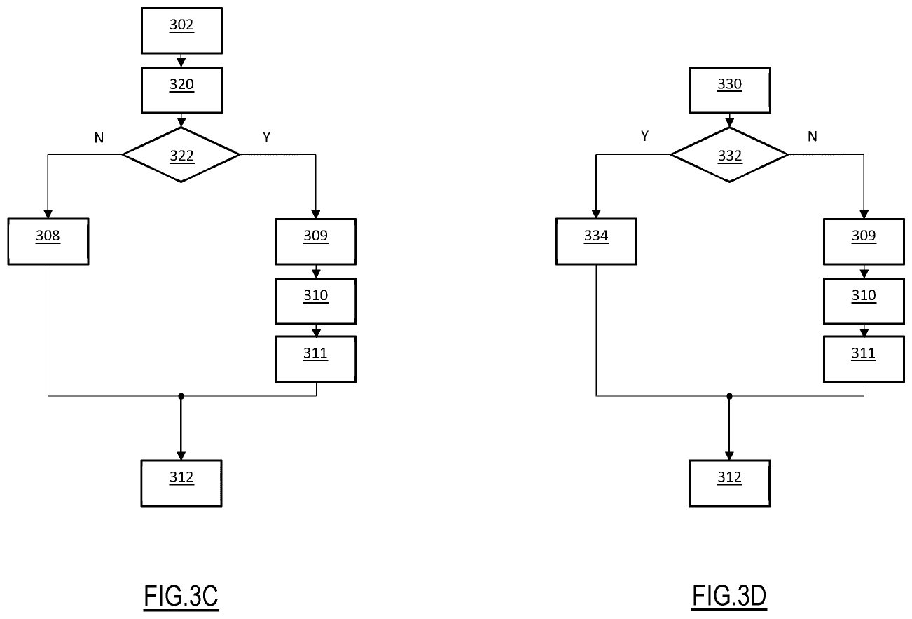

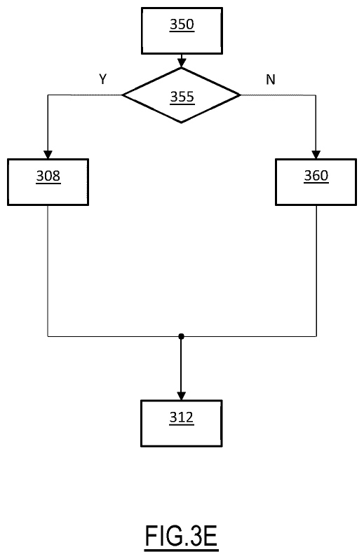

FIG. 3A depicts a flow chart showing main operations performed by the system 100 while operating during the abovementioned present time period PRTP according to an embodiment of the present invention.

According to an embodiment of the present invention, the first computation submodule 120(1) generates a first operative prediction P1 of a number of user terminals UT that will be present in the target area 102 during a corresponding future time period FTP using the historical user terminal density indicators HI as described above (block 302).

According to an embodiment of the present invention, the third computation submodule 120(3) then collects the real time user terminal position indicators RI corresponding to the target area 102 and accordingly calculates a number RNT of user terminals UT that are currently located in the target area 102 based on the collected real time user terminal position indicators RI (block 304).

According to an embodiment of the present invention, the third computation submodule 120(3) compares the number of user terminals UT of the first operative prediction P1 with the calculated number RNT (block 306).

According to an embodiment of the present invention, if the calculated number RNT is not much higher than the number of user terminals UT of the first operative prediction P1, i.e., if the difference between the calculated number RNT and the number of user terminals UT of the first operative prediction P1 is not higher than a corresponding threshold THI, such as for example equal to 100-300 (exit branch N of block 306), the third computation submodule 120(3) provides a network traffic prediction NTP indicative of a number of user terminals UT in the target area 102 that is set According to an embodiment of the present invention, if the calculated number RNT is much higher than the number of user terminals UT of the first operative prediction P1, i.e., if the difference between the calculated number RNT and the number of user terminals UT of the first operative prediction P1 is higher than the threshold THI (exit branch Y of block 306), the third computation submodule 120(3) activates (block 309) the second computation submodule 120(2). The second computation submodule 120(2) then collects the real time user terminal position indicators RI corresponding to the target area 102 and accordingly generates a second operative prediction P2 of a number of user terminals UT that will be present in the target area 102 during the future time period FTP using a combination of the historical user terminal density indicators HI and the collected real time user terminal position indicators RI as described above (block 310). At this point, the third computation submodule 120(3) provides a network traffic prediction NTP indicative of a number of user terminals UT in the target area 102 that is set to the second operative prediction P2 (block 311). According to an embodiment of the present invention, the network traffic prediction NTP provided by the third computation submodule 120(3) (which can be the first operative prediction P1 or the second operative prediction P2, as described above), is fed to the network optimization unit 130, that exploits this information for possibly regulating function parameters of the wireless communication network 105 (block 312). For example, if the network traffic prediction NTP is indicative of a forthcoming peak in the number of user terminals UT in the target area 120, the network optimization unit 130 may control (or instruct) the wireless communication network 105 to increase radio resources assigned to the base stations 105a serving the cells 105b corresponding to the target area 102, and/or drive a drone equipped with a support cell site of the wireless communication network 105 to the target area 102.

Another domain of applicability of the solutions according to the embodiments of the present invention regards the radio emissions by the antennas of the wireless communication network 105. Indeed, in order to avoid violations of regulations concerning radio emissions, each antenna of the base stations 105a of the wireless communication network 105 should keep its hourly radio emission under a corresponding threshold. The larger the number of user terminals UT, the higher the radio emissions. Therefore, in case of unusual large concentrations of user terminals UT in the target area 102, such threshold may be exceeded. Since through the solutions according to the embodiments of the present invention it is possible to predict in advance an unusual large concentration of user terminals UT in the target area 102, the threshold about the maximum hourly radio emission of the antennas of the base stations 105a serving the cells 105b corresponding to the target area 102 can be temporarily raised.

FIG. 3B depicts a flow chart showing main operations performed by the system 100 while the abovementioned present time period PRTP according to another embodiment of the present invention. The operations of the flow chart of FIG. 3B corresponding to operations equivalent to operations already described in the flow chart of FIG. 3A will be depicted by means of blocks having the same references of those used in FIG. 3A, and their description will be omitted or sensibly compressed for the sake of conciseness.

According to an embodiment of the present invention, the first computation submodule 120(1) generates a first operative prediction P1 using the historical user terminal density indicators HI (block 302).

According to an embodiment of the present invention, the third computation submodule 120(3) assesses if the first operative prediction P1 generated by the first computation submodule 120(1) is indicative of a forthcoming peak in the number of user terminals UT (block 316).

According to an embodiment of the present invention, if the first operative prediction P1 is not indicative of a forthcoming peak in the number of user terminals UT (exit branch N of block 316), the third computation submodule 120(3) provides a network traffic prediction NTP indicative of a number of user terminals UT in the target area 102 that is set to the first operative prediction P1 (block 308).

According to an embodiment of the present invention, if the first operative prediction P1 is instead indicative of a forthcoming peak in the number of user terminals UT (exit branch Y of block 316), the third computation submodule 120(3) activates (block 309) the second computation submodule 120(2), which collects the real time user terminal position indicators RI corresponding to the target area 102 and accordingly generates a second operative prediction P2 using a combination of historical user terminal density indicators HI (through which it is possible to calculate predictions about historical trends) and the collected real time user terminal position indicators RI (block 310). Then, the third computation submodule 120(3) provides a network traffic prediction NTP that is set to the second operative prediction P2 (block 311).

According to an embodiment of the present invention, the network traffic prediction NTP provided by the third computation submodule 120(3) is fed to the network optimization unit 130, that exploits this information for possibly regulating function parameters of the wireless communication network 105 (block 312).

FIG. 3C depicts a flow chart showing main operations performed by the system 100 while operating during the abovementioned present time period PRTP according to another embodiment of the present invention. The operations of the flow chart of FIG. 3C corresponding to operations equivalent to operations already described in the flow charts of FIGS. 3A-3B will be depicted by means of blocks having the same references of those used in said figures, and their description will be omitted or sensibly compressed for the sake of conciseness.

According to an embodiment of the present invention, the first computation submodule 120(1) generates a first operative prediction P1 using the historical user terminal density indicators HI (block 302).

According to an embodiment of the present invention, the third computation submodule 120(3) receives calendar data CDATA providing an indication of scheduled increases in the number of user terminals UT in the target area 102 (block 320). For example, the calendar data CDATA may comprise an aggregation of data collected from the Internet, e.g., from websites/social networks providing indication of scheduled events (e.g., a sports match or a concert) causing aggregation of people (which will cause in turn an increase of the density of user terminals UT).

According to an embodiment of the present invention, the third computation submodule 120(3) checks the calendar data CDATA to assess for the presence of forthcoming increases in the number of user terminals UT in the target area 102 (block 322).

According to an embodiment of the present invention, if the calendar data CDATA does not provide for any forthcoming increases in the number of user terminals UT in the target area 102 (exit branch N of block 322), the third computation submodule 120(3) provides a network traffic prediction NTP indicative of a number of user terminals UT in the target area 102 that is set to the first operative prediction P1 (block 308).

According to an embodiment of the present invention, if the calendar data CDATA does provide for a forthcoming increase in the number of user terminals UT in the target area 102 (exit branch Y of block 322), the third computation submodule 120(3) activates (block 309) the second computation submodule 120(2), which collects the real time user terminal position indicators RI corresponding to the target area 102 and accordingly generates a second operative prediction P2 using a combination of the historical user terminal density indicators HI and the collected real time user terminal position indicators RI (block 310). Then, the third computation submodule 120(3) provides a network traffic prediction NTP that is set to the second operative prediction P2 (block 311).

According to an embodiment of the present invention, the network traffic prediction NTP provided by the third computation submodule 120(3) is fed to the network optimization unit 130, that exploits this information for possibly regulating function parameters of the wireless communication network 105 (block 312).

FIG. 3D depicts a flow chart showing main operations performed by the system 100 while operating during the abovementioned present time period PRTP according to another embodiment of the present invention. The operations of the flow chart of FIG. 3D corresponding to operations equivalent to operations already described in the flow charts of FIGS. 3A-3C will be depicted by means of blocks having the same references of those used in said figures, and their description will be omitted or sensibly compressed for the sake of conciseness.

According to an embodiment of the present invention, the first computation submodule 120(1) subdivides a range of possible values for the first operative prediction P1 into a set of sub-intervals SP1(i) (i=1,2, . . . ), and calculates a prediction probability distribution PD (block 330) providing for each sub-interval SP1(i) an indication of the reliability of the prediction corresponding to the values of the sub-interval SP1(i).

According to an embodiment of the present invention, the third computation submodule 120(3) is configured to compare the prediction probability distribution PD with a corresponding reliability threshold RTH (block 332).

According to an embodiment of the present invention, if the prediction probability distribution PD is higher than the reliability threshold RTH only for a single sub-interval SP1(i) (exit branch Y of block 332), the third computation submodule 120(3) provides a network traffic prediction NTP indicative of a number of user terminals UT in the target area 102 that is set to a selected value included in the sub-interval SP1(i) (block 334).

According to an embodiment of the present invention, if the prediction probability distribution PD is always lower than the reliability threshold RTH, (exit branch N of block 332), the third computation submodule 120(3) assesses that that the prediction carried out by the first computation submodule 120(1) is not reliable, and the third computation submodule 120(3) activates (block 309) the second computation submodule 120(2), which collects the real time user terminal position indicators RI corresponding to the target area 102 and accordingly generates a second operative prediction P2 using a combination of the historical user terminal density indicators HI and the collected real time user terminal position indicators RI (block 310). Then, the third computation submodule 120(3) provides a network traffic prediction NTP that is set to the second operative prediction P2 (block 311).

According to an embodiment of the present invention, the network traffic prediction NTP provided by the third computation submodule 120(3) is fed to the network optimization unit 130, that exploits this information for possibly regulating function parameters of the wireless communication network 105 (block 312).

FIG. 3E depicts a flow chart showing main operations performed by the system 100 while operating during the abovementioned present time period PRTP according to another embodiment of the present invention. The operations of the flow chart of FIG. 3E corresponding to operations equivalent to operations already described in the flow charts of FIGS. 3A-3D will be depicted by means of blocks having the same references of those used in said figures, and their description will be omitted or sensibly compressed for the sake of conciseness.

According to an embodiment of the present invention, the first and the second computation submodules 120(1), 120(2) concurrently operate to generate the first and the second operative predictions P1, P2, respectively (block 350).

According to an embodiment of the present invention, the third computation submodule 120(3) compares the first operative prediction P1 with the second operative prediction P2 (block 355).

According to an embodiment of the present invention, if the number of user terminals UT corresponding to the first operative prediction P1 is not lower than the number of user terminals UT corresponding to the second operative prediction P2 by a corresponding threshold TH2, such as for example equal to 100-300 (exit branch Y of block 355), the third computation submodule 120(3) provides a network traffic prediction NTP indicative of a number of user terminals UT in the target area 102 that is set to the first operative prediction P1 (block 308).

According to an embodiment of the present invention, if the number of user terminals UT corresponding to the first operative prediction P1 is lower than the number of user terminals UT corresponding to the second operative prediction P2 by the threshold TH2, because the second operative prediction P2 is indicative of a forthcoming peak in the number of user terminals UT (exit branch N of block 355), the third computation submodule 120(3) provides a network traffic prediction NTP indicative of a number of user terminals UT in the target area 102 that is set to the second operative prediction P2 (block 360).

According to an embodiment of the present invention, the network traffic prediction NTP provided by the third computation submodule 120(3) is fed to the network optimization unit 130, that exploits this information for possibly regulating function parameters of the wireless communication network 105 (block 312).

According to an embodiment of the present invention, the operation of the system 100 may provide for a combination of two or more of the flow charts illustrated in the FIGS. 3A-3E, so that the third computation submodule 120(3) may select which one between the first and second operative predictions P1, P2 is used to provide the network traffic prediction NTP by verifying the fulfillment of more than one condition among the conditions corresponding to the blocks 306, 316, 322, 332, 355 of the flow charts illustrated in the FIGS. 3A-3E.

Naturally, in order to satisfy local and specific requirements, a person skilled in the art may apply to the invention described above many logical and/or physical modifications and alterations. More specifically, although the present invention has been described with a certain degree of particularity with reference to preferred embodiments thereof, it should be understood that various omissions, substitutions and changes in the form and details as well as other embodiments are possible. In particular, different embodiments of the invention may even be practiced without the specific details set forth in the preceding description for providing a more thorough understanding thereof; on the contrary, well-known features may have been omitted or simplified in order not to encumber the description with unnecessary details. Moreover, it is expressly intended that specific elements and/or method steps described in connection with any disclosed embodiment of the invention may be incorporated in any other embodiment.

1. A method for use system in a wireless communication network, the method comprising:
generating a network traffic prediction indicative of a number of user terminals in a target area under radio coverage by the wireless communication network during a first time period following a second time period, the generating comprising:
a first generating a first operative prediction of a number of user terminals in the target area during the first time period based on historical user terminal density indicators indicative of a density of user terminals in the target area in a past time period occurred before the second time period;
a second generating a second operative prediction of the number of user terminals in the target area during the first time period based on a combination of the historical user terminal density indicators and real time user terminal position indicators indicative of a movement of user terminals at the target area during the second time period; and
providing, at the second time period, the network traffic prediction based on a selected one between the first operative prediction and the second operative prediction; and
regulating function parameters of the wireless communication network based on the network traffic prediction.

2. The method of claim 1, wherein the historical user terminal density indicators comprise at least one among:
a number of user terminals connected to the wireless communication network;
a number of user terminals whose last interaction with the wireless communication network occurred in a cell of the wireless communication network corresponding to the target area;
a number of active user terminals; and
traffic volumes caused by user terminals connected to the wireless communication network, collected in the past time period which occurred before the second time period.

3. The method of claim 1, wherein the real time user terminal position indicators comprise at least one among:
GNSS records each containing at least a GNSS position of a user terminal located at the target area during the second time period; and
user terminal position indicators generated by interactions of user terminals at the target area with the wireless communication network during the second time period.

4. The method of claim 1, wherein the first generating the first operative prediction comprises processing the historical user terminal density indicators through a machine learning algorithm.

5. The method of claim 1, wherein the second generating the second operative prediction comprises comparing the historical user terminal density indicators with the real time user terminal position indicators.

6. The method of claim 1, wherein the providing further comprises providing, at the second time period, the network traffic prediction based on the second operative prediction if both the two following conditions are verified:
the number of user terminals corresponding to the first operative prediction is lower than a number of user terminals at the target area assessed based on the real time user terminal position indicators, and
the difference between the number of user terminals at the target area assessed based on the real time user terminal position indicators and the number of user terminals corresponding to the first operative prediction is higher than a threshold.

7. The method of claim 1, wherein the providing further comprises providing, at the second time period, the network traffic prediction based on the second operative prediction if the first operative prediction is indicative of a peak in the number of user terminals in the target area.

8. The method of claim 1, wherein the providing further comprises:
receiving calendar data providing indications of scheduled increases in the number of user terminals in the target area, and
providing, at the second time period, said the network traffic prediction based on the second operative prediction if the calendar data provides an indication of an increase in the number of user terminals in the target area scheduled for the first time period.

9. The method of claim 1, wherein the first generating comprises:
subdividing a range of possible values for the first operative prediction into a set of sub-intervals, and
calculating a prediction probability distribution providing for each sub-interval an indication of a reliability of the first operative prediction corresponding to the values of the sub-interval, wherein the providing, at the second time period, said the network traffic prediction is based on the second operative prediction if the prediction probability distribution is lower than a reliability threshold for all the sub-intervals.

10. The method of claim 1, wherein the providing further comprises providing, at the second time period, said the network traffic prediction based on the second operative prediction if the second operative prediction is indicative of a peak in the number of user terminals in the target area.

11. The method of claim 1, wherein the regulating is performed by a self-organizing-network module.

12. The method of claim 1, further comprising driving a drone equipped with a cell site of the wireless communication network to the target area based on the network traffic prediction.
